(19) United States
(12) Patent Application Publication
(10) Pub. No.: US 2005/0288104 A1
(43) Pub. Date: Dec. 29, 2005

(54) Multifunctional video game and television cabinet

(76) Inventor: Michael Robert Walsh, Chicago, IL (US)

Correspondence Address: DOUGLAS F. KIMBALL, 612 WEBSTER AVENUE, WHEATON, IL, 60187, US

(21) Appl. No.: 10/878,798

(22) Filed: Jun. 28, 2004

(51) Int. Cl. A63F 13/00; A63F 9/24

(52) U.S. Cl. 463/46

(57) ABSTRACT

An electronic video game cabinet, that includes a monitor compartment attached to a swivel component. The monitor compartment sits on top of a base compartment with the swivel component attached to base compartment. This arrangement allows the monitor compartment to be rotated so that the monitor could be viewed from anywhere in the room. The monitor compartment has space for a video console, speakers and games. The base compartment is designed to accommodate a seat, additional speakers, a computer and a control panel.

### BACKGROUND OF THE INVENTION

The present invention relates to cabinets that support and contain video games, television sets and the like. Specifically, this invention relates to a cabinet for home use that effectively combines a video game cockpit style cabinet with a television stand.

Video games are a popular form of entertainment with games and game platforms appearing on the market constantly. Widespread access to the games has created multiple markets for the games. One such market is the arcade style game. In this game system, the player or players will insert coins or tokens into the game and play each other or play against the video game program. These arcade video games have gotten more elaborate and the graphics more realistic and detailed with each iteration of the games. One thing the arcade style video games have done to improve their realistic effects is to enclose the display screen and controls in mock enclosure that would complement the story of the game. Thus, if the game was the simulation of a jet fighter combat sequence, the enclosure for the game would attempt to simulate the cockpit of an ultramodern jet fighter aircraft. If the game was a simulation of a car race, the enclosure for the game would attempt to simulate cockpit of racecar. The enclosure enhanced the enjoyment of the game by allowing for better placement of the speakers that provided sound and foot and hand controls that were closer to the controls used in the actual jet fighter or racecar. The enclosure also decreased the distraction from other people or other games in a place where there were many video games and people.

Another market for video games is the home market. Similar games to the arcade market have appeared for the home market. The person who wants to play video games at home must invest in the equipment and games at substantial cost, but they can be played without incurring any cost after the initial investment. The home video games have a console that contains the electronic components and places where various attachments, such as speakers, joysticks or steering wheels can electronically connected to the counsel and control the action of the game. The games themselves are in a permanent form of computer readable memory like compact discs or plug in cartridges. Thus many games can be played with only one console but various attachments can be incorporated to enhance any one game.

One problem with the video games in the home, is that the cables and wires connecting the video game and the attachments are usually laying all over the floor. Another problem is if the game is set up ideally to play video games, furniture is often too close for television viewing. So the television monitor or the furniture has to constantly be shifted in location to accommodate the desired activity. The other choice is to have a television monitor specifically for the video game and another specifically for television viewing. This choice is expensive and uses valuable floor space in the living environment.

The above disadvantages and the desire to have a better game playing environment for the home has led to the invention of a cabinet for video games that solves these problems.

### SUMMARY OF THE INVENTION

Therefore, the object of the invention is to provide a cabinet for, the video game that would provide arcade features such as a well designed seat and places to mount controls and attachments to the video game the would enhance the player experience.

Another object of the invention is to provide a rotatable mounting for the television monitor so that when the television was being viewed in the television mode of operation, it could be rotated and viewed from other locations in the room thus making it possible to locate the cabinet virtually anyplace in a room. Thus the monitor could be easily rotated from a position for game playing to the television viewing position. The monitor would be either in excellent position for game playing or in an excellent position for television viewing simply by rotating the orientation of the monitor.

Another object of the invention is to have a cabinet that contains all the wiring and cables for the game so that the area around the game will not be cluttered with the cables.

A further aspect of the invention is to have a convenient mounting and storage cabinet especially for the video game. The storage area would also accommodate additional games.

### BRIEF DESCRIPTION OF THE DRAWINGS

FIG. 1 is a side view of the invention with the monitor turned so that it could be viewed from the room, in a television viewing orientation.

FIG. 2 is a side view of the cabinet with the monitor in the game playing orientation.

FIG. 3 is a detailed side view of the swivel base of the monitor compartment and the control panel incorporating a steering wheel in this configuration.

FIG. 4 is a side view as in FIG. 3 with a joystick incorporated on the control panel.

FIG. 5 is a front view of the cabinet showing a computer keyboard on the control panel. In this view the seat and associated cabinetry has not been indicated.

FIG. 6 is a front view of the control panel showing details configured with a steering wheel similar to FIG. 3.

FIG. 7 is a front view of the control panel showing details configured with a joystick similar to FIG. 4.

FIG. 8 is a front view of the cabinet with the seat and associated cabinetry in place.

FIG. 9 is a view of the rear of the cabinet showing the rear of the monitor etc.

### DETAILED DESCRIPTION OF THE INVENTION

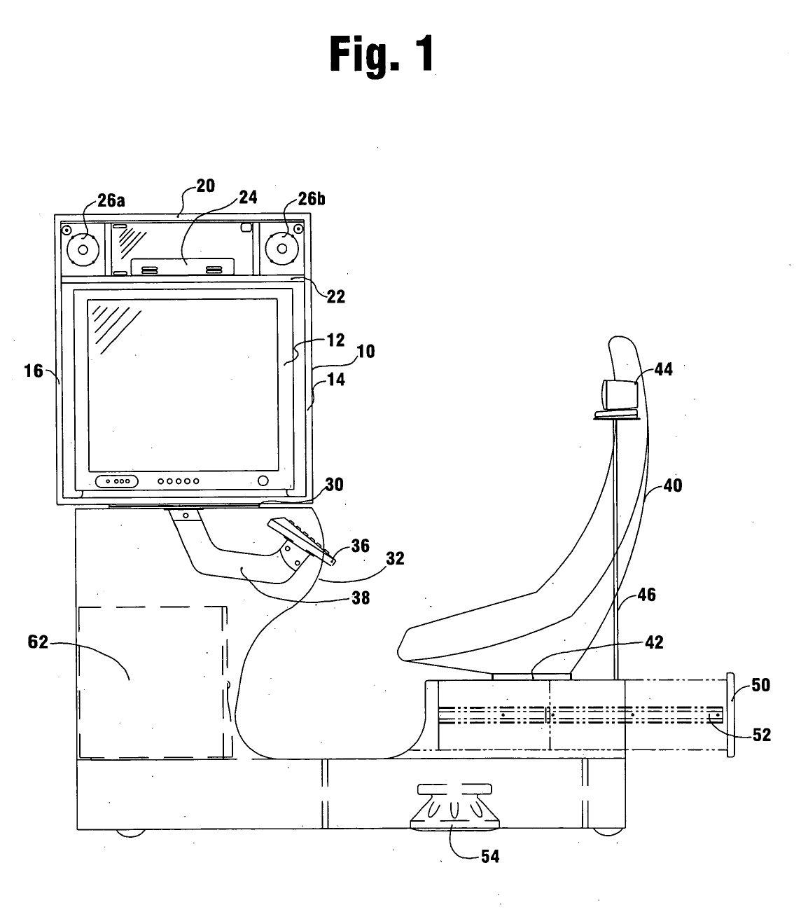

The drawings indicate an embodiment of the invention. FIG. 1 shows a view from the side of cabinet with the monitor swiveled to face the viewer in the room. This is the way the invention would look when it was in a positioned for television viewing in the room. The monitor compartment 10 contains a monitor 12. The monitor compartment is a box-like structure that is made of two identical or nearly identical sides 14 and 16 and a bottom 18 piece and a top 20 piece. The monitor compartment 10 would be big enough to have a television monitor of at least 27 inches placed in side the compartment. This size monitor is an excellent monitor for the dual use of playing video games or watching television. Above the monitor is a shelf 22 that would support the video game console 24. Mounted on either side of the console are two speakers 26a and 26b that provide sound that comes from the direction of the monitor.

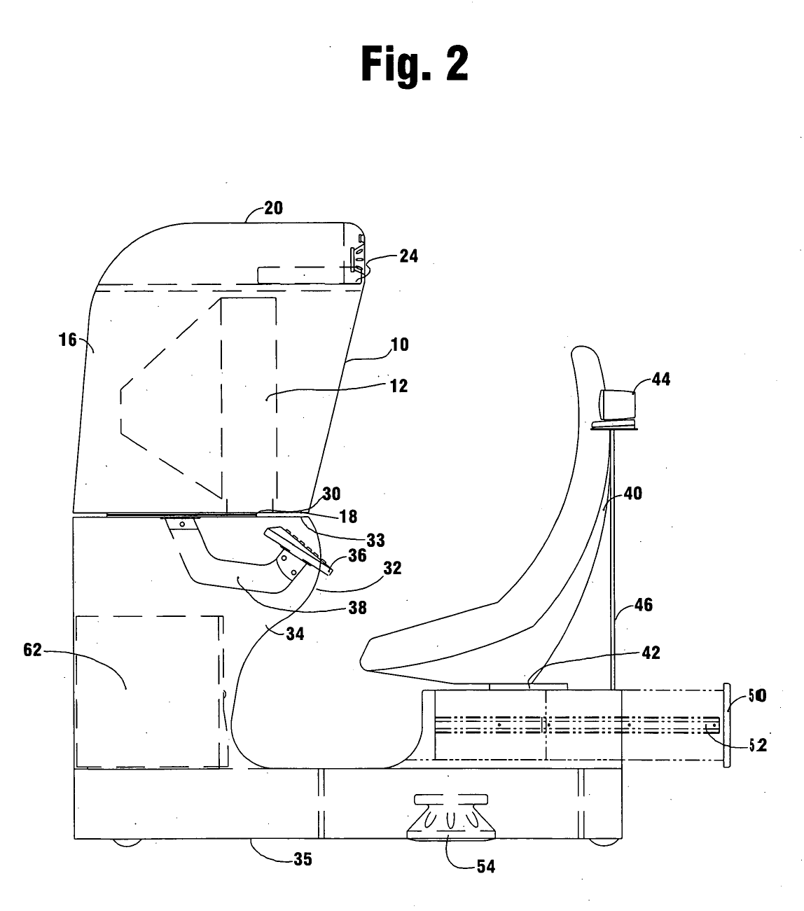

The bottom 18 piece of the monitor compartment sets on a swivel base 30. The swivel base is a key element of the invention and allows the monitor to be viewed in the correct position for television viewing as shown in FIG. 1 or rotated about 90 degrees for video game playing as shown in FIG. 2. FIG. 1 shows the monitor in a position to be used as a television monitor that can be viewed from any position in the room. FIG. 1 has the monitor at about 90 degrees from the position the monitor is in FIG. 2. However, the monitor compartment and monitor could be at any rotational point in a full circle to accommodate the exact configuration of the room. The swivel base 30 has elements such as screws or bolts that allow it to engage and be securely attached to the monitor compartment on one side and supporting structure on the other side of the swivel base.

The swivel base 30 sets atop and is attached to the base compartment 32 of the cabinet that has appropriate structure to support the monitor compartment 10. The base compartment needs to elevate the monitor compartment about 30 to 45 inches off the floor for proper alignment and ease of viewing. The base compartment 32 could take many shapes in addition to the one pictured in FIGS. 1 and 2 but that shape is intended to simulate an arcade experience. Other base compartments would be obvious to one familiar with the cabinetmaker's art. A control panel 36 is incorporated into the base compartment and is positioned directly below the monitor compartment to allow for mounting a keyboard or any other type of game controlling devices and attachments as need dictates. It is expected that the control panel could be customized to a particular set of video game control attachments or it could be generic so that as new video consoles and attachments became available, the control panel could accommodate the new equipment. A mounting structure 38 for the control panel would also route the cables from the control panel to the computer or game console. Cable management compartments and openings would be throughout structure to organize the various cables that are necessary for the game console and components to function correctly. The base compartment left-side panel 34 would screen the mounting structure 38 from the room.

Supported in the base compartment 32 is a seat 40. The seat would be mounted on sliding rails 42 that would allow the distance from the seat to the control panel to be adjusted. Persons of various body sizes could adjust the seat so they could comfortably fit in the seat and manipulate the control attachments of the video game. Seats like this are directly available form the automotive industry suppliers and can be adapted to fit in the invention. The seat could be, depending the expense a person wanted to invest in the cabinet, very luxurious or simple. A more versatile seat not only adjusts back and forth on rails but also swivels so that it could face outward like the monitor. This would give extra seating in a small room so that the person sitting in that seat could interact with the other people in the room.

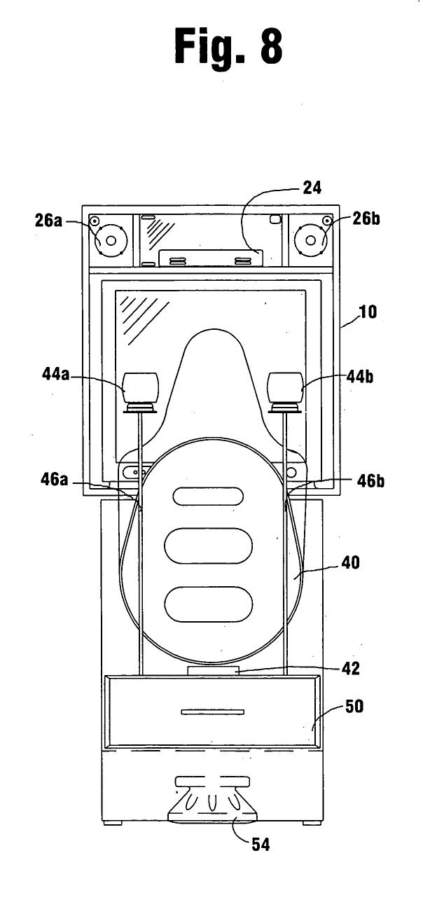

Another pair of speakers (44 in FIG. 1 and 2 and indicated as 44a and 44b in FIG. 8) are mounted on supports 46 close to the seat. These speakers give the audio portion of the game a more realistic surround-sound effect. Underneath the seat is a drawer 50 mounted on a standard drawer rail 52 that can be used for storage of games or accessories. On the bottom (35 of FIG. 2) of the base cabinet is mounted a speaker 54 designed to give special low frequency sound to the person in the seat. The low frequency sound is used in video games to simulate certain effects such as a car engine or explosion. A computer 62 can be placed in the base compartment underneath the monitor compartment. The personal computer can be used as method to play video games or as a general purpose personal computer.

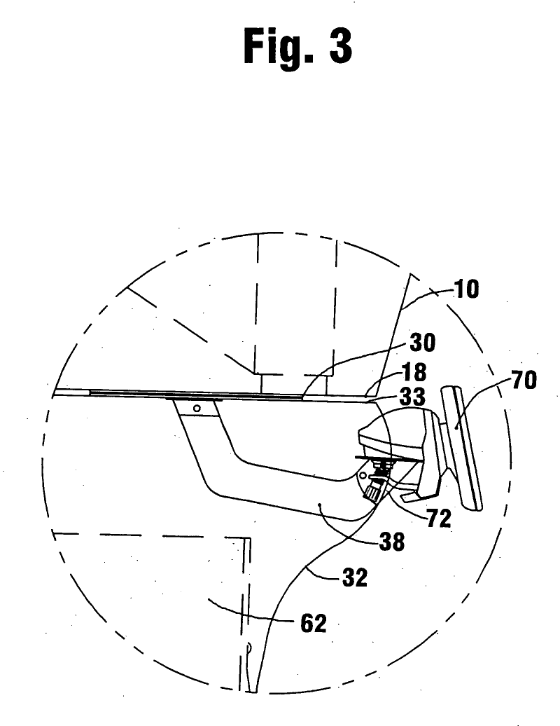

FIG. 3 shows an enlarged view of the control panel with a steering wheel 70 in place. The monitor compartment sits on its bottom piece 18 that is securely connected to the top of the swivel support 30. The top piece 33 of the base compartment 32 is securely connected to the bottom of the swivel support 30 so that the monitor compartment can be rotated. The steering wheel 70 is mounted on the support arm 38. An adjustable support mechanism 72 allows the angle of the steering wheel to be adjusted with respect to the vertical plane. This type of mounting would allow customization of the steering wheel angle to the individual game player. The support arm 38 for the control panel also routes the electronic cables to the computer 62 or the video game console.

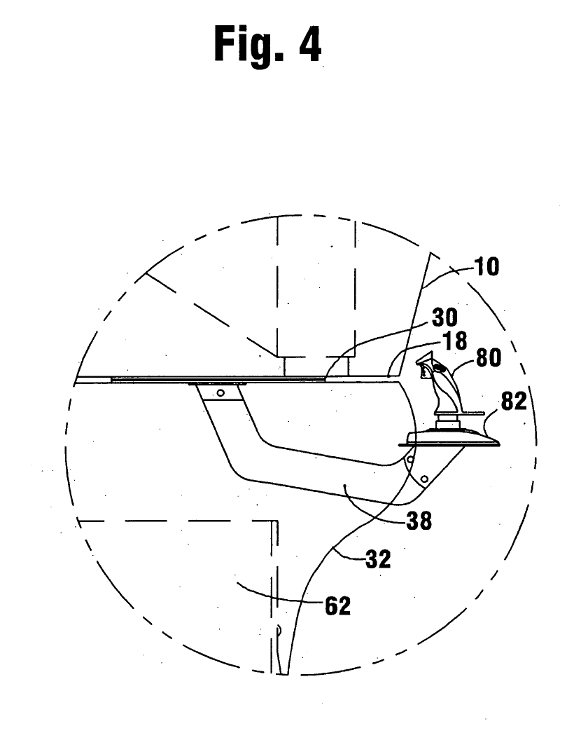

FIG. 4 is a similar view except that the steering wheel 70 has been replaced by a joystick 80 and the joystick base 82.

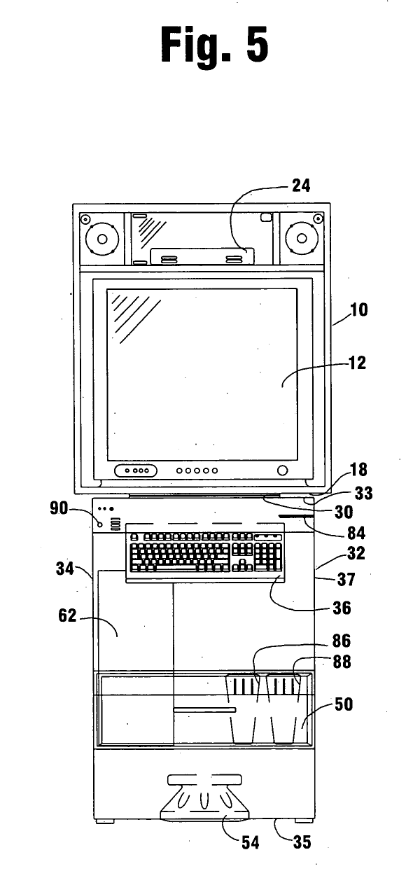

FIG. 5 is a view towards the monitor and control panel from the position of the seat. This is considered the rear of the cabinet. Additional elements of the invention visible from this view are a cup holder 84 and a left 86 and right 88 foot pedals. The foot pedals would be used in video games that simulate a racing car and the like to simulate the control mechanisms of a racing car. A keyboard 36 is shown on the control panel and the front of the computer 62 is shown where disks can be loaded to program the computer. An additional locking mechanism 90 is incorporated to allow parental control of video games when they are not present.

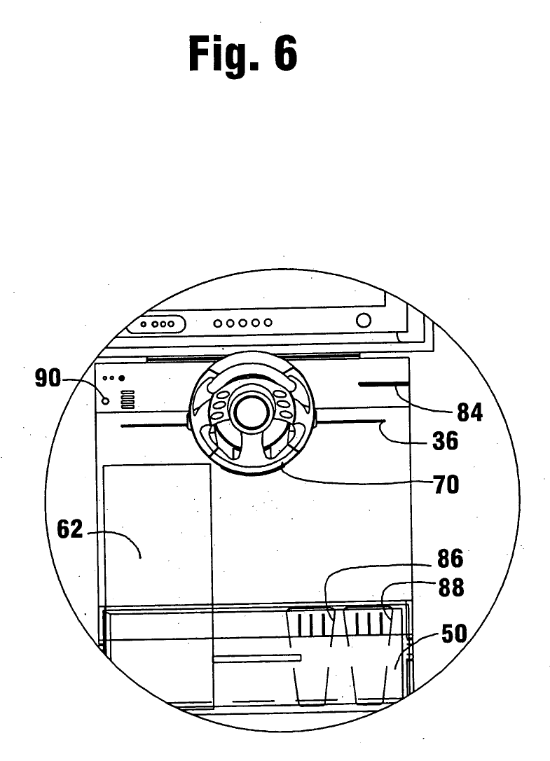

FIG. 6 is an expanded view of the control panel 36 area of the cabinet from the same orientation as FIG. 5. In FIG. 6 a steering wheel 70 is in position on the control panel.

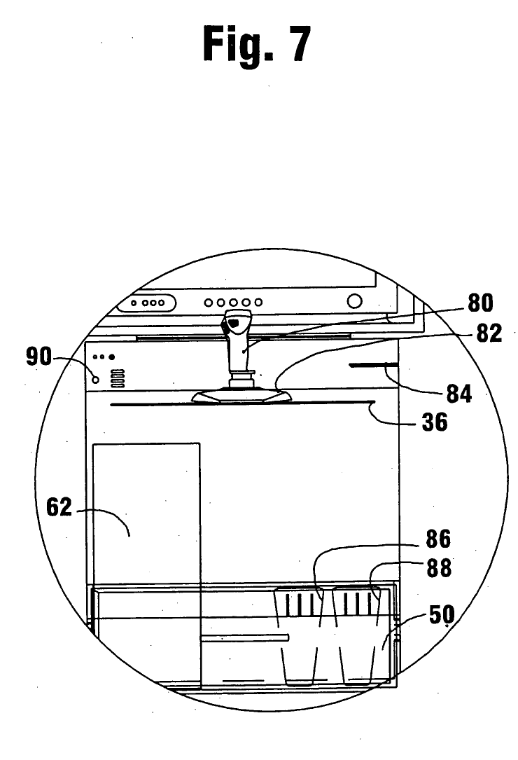

FIG. 7 is an expanded view of the control panel 36 area of the cabinet from the same orientation as FIG. 5 with a joystick 80 and base 82 mounted on the control panel 36.

FIG. 8 is a view from the rear of the cabinet as in FIG. 5 but with the chair 40 and speakers 44a and 44b shown in place. The supports for the speakers 46a and 46b, the slidable mount 42 for the seat and the drawer 50 are also indicated.

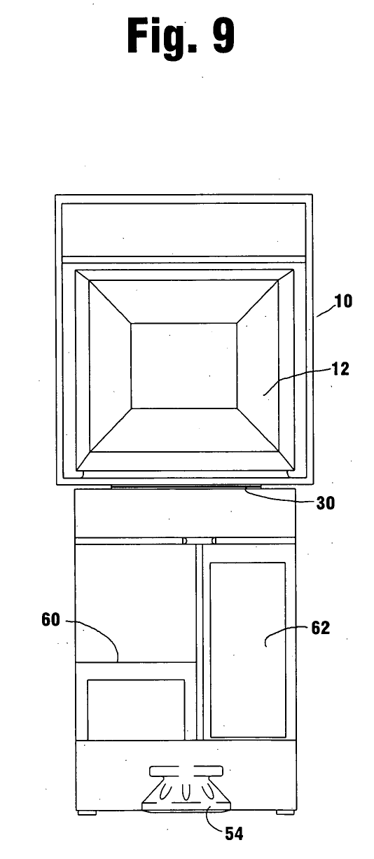

FIG. 9 is a view of the cabinet as seen from 180 degrees from the orientation shown in FIG. 5. This shows the open configuration of the monitor compartment 10 and the base compartment 32. The rear of the monitor 12 is seen and the rear of the computer 62. The computer is indicated as a mini-tower which is popular configuration, but cabinet makers familiar with the art could make any size or shaped compartment to handle various computer of various physical dimensions. The rear is largely open to allow air to circulate through the electronic components. Although represented as completely open, it is likely that the rear of the cabinet would be covered with a panel that would have a large number of holes or slates cut in to it to allow for air circulation. A support 60 for the foot pedals can also be seen.

1. A video game cabinet comprising:
a television monitor compartment having a top, a bottom, a left side and a right side interconnected to define a box-like enclosure, said box-like enclosure defining an interior and exterior surface and said bottom exterior surface being attached to an upper engaging section of a swivel base apparatus;
a base compartment supporting said television monitor compartment having a support to engage a lower engaging section of the swivel base apparatus whereby the television monitor compartment can be pivoted in a horizontal plane.

2. A video game cabinet as claimed in claim 1 wherein the cabinet supports a control panel whereby game controlling attachments can be mounted.

3. A video game cabinet as claimed in claim 1 wherein the base compartment has a seat that is slideably attached to the base cabinet.

4. A video game cabinet as claimed in claim 1 wherein the television monitor compartment has a storage shelf for a video game console.

5. A video game cabinet as claimed in claim 1 wherein the cabinet supports a seat that is pivotally mounted to the cabinet.

6. A video game cabinet as claimed in claim 1 wherein the base compartment is configured to contain a computer.

7. A video game cabinet as claimed in claim 1 wherein the cabinet contains a cable management compartment whereby cables from various components of video games and computers can be routed to appropriate devices.

8. A video game cabinet as claimed in claim 1 wherein the cabinet contains a plurality of speaker mounting locations.

9. A video game cabinet as claimed in claim 1 wherein the cabinet has a drawer for storage.

10. A video game cabinet as claimed in claim 1 wherein the cabinet has a keyed lock device that prevents playing of video games when the keyed lock device is in the locked position.

11. A video game cabinet as claimed in claim 1 wherein the cabinet has a plurality of foot pedals whereby the driving experience of a car is simulated.

12. A video game cabinet as claimed in claim 1 wherein the cabinet has a cup holder.
